(19) United States
(12) Patent Application Publication
(10) Pub. No.: US 2026/0047548 A1
(43) Pub. Date: Feb. 19, 2026

(54) DEVICE FOR DISPENSING ANIMAL FEED, AND METHOD FOR DISPENSING WET FEED IMPLEMENTED BY A DEVICE OF THIS KIND

(71) Applicants: YOPI, Rouen (FR); CEVA SANTE ANIMALE, LIBOURNE (FR)

(72) Inventors: Pierre Caron, PARIS (FR); Yoan Pochet, PARIS (FR)

(21) Appl. No.: 18/868,651

(22) PCT Filed: May 23, 2023
(86) PCT No.: PCT/EP2023/063854

§ 371 Date: Oct. 8, 2025

(30) Foreign Application Priority Data
May 23, 2022 (FR) FR2204925

(51) Int. Cl. A01K 5/01; A01K 5/02; B65D 75/56; B65D 75/58

(52) U.S. Cl. CPC A01K 5/0114; A01K 5/0216; A01K 5/0275; B65D 75/566; B65D 75/5866

(57) ABSTRACT

The invention relates to a device (2) for dispensing animal feed, the device (2) comprising a casing (6) inside which a feed receptacle (8A) and a wet feed dispensing unit (10) are arranged. The wet feed dispensing unit (10) is suitable for receiving a removable bag (4) of wet feed provided with an opening neck for the bag (4), the wet feed dispensing unit (10) comprising:—an electromechanical device (24) for supplying wet feed from the bag (4) to the feed receptacle (8A), comprising means (36B) for squeezing and/or pressing the bag (4) and means (38, 38A, 38B) for pinching at least one edge of the bag (4), said pinching means (38, 38A, 38B) being motorized and being mounted so as to be movable between a push position in which said at least one edge of the bag (4) is pushed towards the neck, and a pull position in which said at least one edge of the bag (4) is pulled away from the neck; and—means for controlling the electromechanical device (24), which are able to control dispensing of the wet feed from the bag (4) towards the feed receptacle (8A).

The invention relates to the field of devices for dispensing animal feed (especially wet feed), typically for small pets such as cats or dogs. The wet feed is, for example, (but is not limited to) animal pâté. The invention also relates to an assembly comprising such a device and a bag of wet feed installed within the device; as well as to a wet feed dispensing method implemented by such a device.

In the field of devices for dispensing animal feed, feed receptacles are known which control the animal's access to wet feed. For example, prior art solutions involve equipping the animal (e.g. a cat) with a microchip, typically worn on a collar around the animal's neck or via an intradermal chip. For example, the receptacle is fitted with a movable lid that prevents access to feed when closed. The receptacle is equipped with electronic control means for opening the lid, as well as chip recognition means (e.g. a detection hoop) connected to the control means. In this way, the animal equipped with the chip approaching the receptacle controls the opening of the lid, releasing access to the wet feed. However, a disadvantage of this type of receptacle is that it requires manual refilling by the user for each dispensing of feed. What's more, once wet feed has been removed from its packaging, even when protected from the ambient air, it oxidizes in around four to eight hours.

There is therefore a need to be able to dispense wet feed (such as pâté) automatically and repeatedly, making it easier for the user to go about their business while meeting the animal's nutritional requirements. For this purpose, dispensers are known which automatically deliver predefined doses of wet feed. U.S. Pat. No. 9,232,769 B1, for example, describes such a wet feed dispenser. The dispenser comprises a feed dispensing unit and a number of bags of wet feed arranged in the upper part of the unit. The feed dispensing unit is provided with a casing, a receptacle arranged in the lower part of the casing; an electromechanical device arranged in the middle part of the casing for supplying feed from the bags to the receptacle; and means for controlling the electromechanical device. Each bag is secured to the casing from the top and bottom, via top and bottom retaining clips provided on the casing. The electromechanical device comprises a servomotor fitted with a shaft, itself connected to a belt/pulley system. The belt is connected to a mobile arm via a connector which passes through a channel formed in the casing. The arm, which is fitted with a rotating blade at its free end, is thus translated along the channel by the action of the motorized belt/pulley system. In operation, the arm with its blade cuts through one end of the bags pre-positioned on the casing, enabling wet feed to be dispensed into the receptacle. However, a disadvantage of the feed dispenser described in this patent document is that it requires a whole bag of wet feed to be consumed for each dose of feed dispensed. This leads to wasted feed and overconsumption by the animal, and undermines the device's autonomy.

A further disadvantage of such a dispenser is that it cannot guarantee bacteriological and anti-oxidation protection for wet feed. This is because the feed receptacle and opening mechanism, and even the bags themselves once opened, remain in contact with the air, which carries germs and bacteria that are themselves sources of bacteriological contamination.

The aim of the invention is therefore to provide a device for dispensing feed, particularly wet feed, for animals, which makes it possible to dose a precise quantity of wet feed suitable for the animal, and therefore both to avoid wasting feed and to increase the autonomy of the device (while saving on feed refills).

Another aim of the invention is to provide a simple and reliable automated device for dispensing wet animal feed, in particular, which guarantees the bacteriological and anti-oxidation protection of the wet feed.

To achieve these objectives, the present disclosure relates to a device for dispensing feed for animals, this device comprising a casing including a feed receptacle and a wet feed dispensing unit, the wet feed dispensing unit being adapted to receive a removable bag of wet feed, this wet feed dispensing unit being configured to ensure the holding and securing of said bag so that the latter then extends at least partially along a main axis, said bag being provided with an opening neck for the bag, the neck being deformable between at least an open position and a closed position, being provided on a lower part of the bag and being arranged facing the feed receptacle when the bag is received in the wet feed dispensing unit, the wet feed dispensing unit comprising:
an electromechanical device for supplying wet feed from the bag to the feed receptacle, and
control means for the electromechanical device, capable of controlling the delivery of wet feed from the bag to the feed receptacle.

According to the invention, the electromechanical device comprises:
at least one block comprising a gripping element for holding a portion of said bag arranged laterally to said neck, said gripping element being mounted for translational movement along an axis that is transverse or substantially transverse to said main axis, and a motor for driving said gripping element to move between a position of said portion of said bag held in this way, corresponding to a neck-opening position, and a position of pulling away said portion of said bag held in this way, corresponding to said neck-closing position,
said blocks being configured to hold a first portion and a second portion of said bag placed laterally to said neck, and located on either side thereof, when said electromechanical device comprises two blocks,
said electromechanical device comprising at least one element for holding a second portion of said bag placed laterally to said neck, when it comprises a single block for gripping a first portion of said bag placed laterally to said neck, said first and second portions being located on either side of said neck, and
said blocks, or said block and said holding element, being configured to enable said neck to be opened or closed selectively, with said first and second portions of the bag being tensioned in the pull position to close said neck and guarantee the bacteriological and anti-oxidation protection of the wet feed.

The present disclosure advantageously makes it possible to keep the same bag, which has been opened, for longer in the wet feed dispensing unit, without altering the quality of its contents. Tests have shown that the same 500 gram bag of wet feed (bi-nutrition) can be used for between two (2) and five (5) days at room temperature in the feed dispenser, after it has been opened. There is no need to store the bag in a refrigerated compartment after opening.

Preferably, the casing comprises a one-piece, die-cast aluminum shell.

The present disclosure also relates to a device for dispensing feed for animals, this device comprising a casing including a feed receptacle and a wet feed dispensing unit, the wet feed dispensing unit being adapted to receive a removable bag of wet feed, adapted to be held and secured within the housing and provided with a neck for opening the bag, the neck being deformable between at least an open position and a closed position, being provided on a lower part of the bag and being arranged facing the feed receptacle when the bag is received in the wet feed dispensing unit, the wet feed dispensing unit comprising:
an electromechanical device for supplying wet feed from the bag to the feed receptacle; and
control means for the electromechanical device, capable of controlling the delivery of wet feed from the bag to the feed receptacle.

According to the invention, the electromechanical device comprises:
a bag squeezing/pressing assembly movable along a main axis to squeeze and/or press at least part of said bag, and
a first block comprising:
a first element for gripping a first portion of the bag disposed laterally to the neck, the first gripping element being mounted for translational movement along an axis transverse or substantially transverse to a main axis defined by the axis of movement of the bag squeezing/pressing assembly, and
a motor for moving the first gripping element between:
a position of the first portion of the bag thus gripped, corresponding to a neck-opening position, and
a position of pulling away the first portion of the bag thus gripped, corresponding to a neck-closing position,
a second block comprising:
a second element for gripping a second portion of the bag positioned laterally to the neck, the first and second portions of the bag being located on either side of the neck,
the second gripping element being either fixed to form a holding element for the second portion of the bag, or mounted for translational movement along the axis transverse or substantially transverse to the main axis defined by the axis of movement of the bag squeezing/pressing assembly,
the first and second blocks being configured to enable the neck to be opened or closed selectively, with the first and second portions of the bag being tensioned in the pull position to close the neck and guarantee the bacteriological and anti-oxidation protection of the wet feed.

The present disclosure also relates to a device for dispensing feed for animals, this device comprising a casing wherein a feed receptacle and a wet feed dispensing unit are arranged, the wet feed dispensing unit being adapted to receive a removable bag of wet feed, adapted to be held and secured within the housing and provided with a neck for opening the bag, the neck being deformable between an open position and a closed position, being provided on a lower part of the bag and being arranged facing the feed receptacle when the bag is received in the wet feed dispensing unit, the wet feed dispensing unit comprising:
an electromechanical device for supplying wet feed from the bag to the feed receptacle; and
control means for the electromechanical device, capable of controlling the delivery of wet feed from the bag to the feed receptacle.

According to the invention, the electromechanical device comprises:
bag squeezing and/or pressing means; and
means for gripping at least one edge of the bag, said gripping means being motorized and mounted so as to be movable between a push position in which said at least one edge of the bag is pushed towards the neck, and a pull position in which said at least one edge of the bag is pulled away from the neck, the bag being configured so that the pushing position of said at least one edge of the bag corresponds to the neck-opening position, and the pull position of said at least one edge of the bag corresponds to the neck-closing position, the gripping means being configured to enable selective opening or closing of the neck.

Although suitable for dispensing feed to all types of animals (especially pets), the device according to the invention is particularly well suited to dispensing feed to cats, whose physiological needs require a moist diet (most of them do not drink enough), and whose biological rhythm leads to about ten small meals every twenty-four hours. The wet feed dispensed can be animal pâté, particularly pâté for cats.

Thanks to the particular configuration of the bag, combined with the presence in the electromechanical device of means for squeezing and/or pressing the bag and means for pinching at least one edge of the bag, the feed dispensing device according to the invention makes it possible to dose a precise amount of wet feed suitable for the animal (and in particular to deliver precise personalized doses of feed, typically doses of wet feed ranging from 10 g to 100 g). In addition, as the neck of the bag is deformable between an open position and a closed position by pulling or pushing on the edge of the bag, and as the gripping means are configured to allow selective opening or closing of the neck, the interior of the neck (and therefore of the bag) remains airtight outside periods of wet feed dispensing, due to the closing of the neck. The contents of the opened bag remain air-and bacteria-tight for the duration of the emptying process, as the opening surface of the neck is minimal, almost always sealed, with no residues (which fall by gravity), and inside a fully enclosed machine (no contact with pets or insects). In addition, as the neck of the bag is integral with it and acts as a stopper thanks to the means for pinching at least one edge of the bag, all the feed passing through the neck either falls into the receptacle by gravity, or remains hanging in the completely sealed neck. As a result, no air comes into contact with the contents of the neck (and by extension the bag). This guarantees effective bacteriological and anti-oxidation protection for wet feed. It should also be noted that the bag has no gaskets, stoppers or moving attachments, nor is there any residue on the outside; nor is there any suction sucking air into the bag: the feed is pushed out of the bag, or remains safely inside it. The constant upright position of the bag also means that the wet feed closes the opening of the neck and prevents air from entering. On the other hand, the doses of wet feed dispensed and any residues are protected from external contact (via the shroud provided by the casing of the device) and do not come into contact with the mechanical parts of the device but only with the various feed receptacles, which are preferably removable and thus constitute the only parts of the device requiring cleaning. In fact, the doses of wet feed dispensed and the residues fall directly by gravity into the device's various feed receptacles, without ever touching any part of the electromechanical device. Lastly, the feed dispensing device according to the invention is simple, reliable and has good autonomy (due to the dispensing of predefined doses corresponding to portions of wet feed contained in the bag).

According to one embodiment of the device for dispensing animal feed, each gripping element is configured to grip a portion of said bag located between said neck and a corresponding lateral edge of said bag, said neck being excluded.

According to another embodiment of the device for dispensing animal feed, said holding element is a lug or a fixed gripping element.

The term “lug” refers to a small projecting part designed to engage in a hole provided for this purpose in the corresponding side of said bag.

According to yet another embodiment of the device for dispensing animal feed, the neck of said bag having at least two stable opening geometries, when said or each block holds a corresponding portion of said bag disposed laterally to the neck in predetermined opening positions thereof, each block is configured to pass selectively from the neck-closing position to each opening position, each of these positions being reached by translational movement of said block or blocks along said transverse axis.

Advantageously, it is then possible to adjust the shape of the neck to suit the rheology and/or the number of phases/components of the wet feed, such as two-component pâtés. In the latter case, the product may be, for example, a pâté with chunks in the jelly.

By way of illustration only, a first of the said opening positions corresponding to a stable opening geometry of the neck, the so-called forced-open position, corresponds to a position of the or each block, wherein it pushes a corresponding part of said bag arranged laterally to said neck.

To perform this push, the corresponding block moves towards the neck.

This forced-open position corresponds, for example, to a “full-open” neck geometry, and to a circular or substantially circular neck cross-section, the latter being reached when the position of said at least one block is closest to said neck.

According to another illustration, another of said opening positions corresponding to a stable opening geometry of the neck, called normal opening position of the bag, corresponds to a position of said or each block, wherein the corresponding part of said bag arranged laterally to said neck is not tensioned by said block.

For example, this stable opening position corresponds to a neck opening geometry wherein the neck has a straight cat's-eye cross-section.

According to yet another embodiment of the device for dispensing animal feed, each block is configured so that the transverse or substantially transverse axis of movement of its gripping element is positioned between the lower and upper ends of said neck when the bag is held in said casing.

According to yet another embodiment of the device for dispensing animal feed, each gripping element comprises one or more objects selected from the group comprising teeth, pointed elements such as needles or pins, pressure bars with or without rubber, a fastening pin or stud intended to cooperate with a corresponding orifice placed in the lower part of the bag, shapes and counter-shapes, and combinations of these elements.

According to yet another embodiment of the device for dispensing animal feed, each gripping element is formed by a gripping jaw for gripping said bag portion disposed laterally to said neck by each of the faces of said bag.

According to yet another embodiment of the device for dispensing animal feed, said electromechanical device further comprises an assembly for squeezing and/or pressing said bag, said assembly defining a main axis along which said assembly for squeezing and/or pressing said bag moves to squeeze and/or press at least a portion of said bag.

Preferably, said bag squeezing and/or pressing assembly comprises two parallel motorized rollers, each of the rollers being mounted for translational movement along said main axis within the casing and extending in a direction transverse to said main axis, the bag being intended to extend between the rollers by being held by squeezing between the rollers when the bag is received in the wet feed dispensing unit, the neck of the bag extending below the rollers.

As the rollers move downwards, the wet feed slides towards the neck of the bag, and thus towards the bag outlet, dropping by gravity into the feed receptacle. Such a configuration, using parallel motorized rollers to squeeze and/or press the bag, enables the bag to be effectively pressed to drop the wet feed into the receptacle, while adapting the length by which the rollers descend to both the dose of wet feed to be dispensed and the height at which the rollers are located relative to the bag (1 cm descended by the rollers squeezes out a varying amount of wet feed depending on the relative position of the rollers to the bag). To this end, a linear regression law can advantageously be implemented in a data processing unit to control the movement of the rollers (profile, speed, pressure, height descended, etc.), in order to control the flow of wet feed and the uniform dispensing of doses whatever the position of the rollers.

Advantageously, the two parallel rollers extend in the same horizontal plane when in the bag squeezing position, each of the two rollers extending in a direction perpendicular to the vertical direction.

Preferably, said device for dispensing animal feed comprises at least one pair of guide rail portions positioned opposite each other in the upper part of the casing, said guide rail portions enabling said rollers to be guided between a stowed or retracted position and an operating position, wherein said rollers are engaged with said bag, the upper ends of said rail portions bringing said rollers to their retracted position being inclined to increase the distance separating these rollers and facilitate the positioning of the bag in the wet feed dispensing unit when the rollers are in the retracted position.

Advantageously, said retracted position is positioned above fastening elements for hanging said bag in the wet feed dispensing unit.

According to yet another embodiment of the device for dispensing animal feed, the electromechanical device further comprises at least one roller support part, preferably two roller support parts, said at least one support part being connected to a motor or servomotor enabling its translational movement inside the casing, said at least one support part having a first portion for holding one of the two rollers configured so as to form a pivot connection for said roller, and a second portion for holding the other roller, said second portion of the part being provided with an oblong-shaped recess configured to receive, as a function of the translational movement of the rollers in the casing, said other roller in a first portion of the recess, corresponding to a position in which the rollers are brought together, or in a second portion of the recess, corresponding to a position in which the rollers are moved apart, the first and second portions of the oblong-shaped recess being offset from one another vertically and/or horizontally. Such a configured support part provides an effective means of enabling easy insertion of the bag between the rollers when it is installed in the device, while allowing the rollers to be brought closer together and thus squeezing the bag when the vertical descent movement of the rollers is initiated. This is because, when the support part is driven downwards by the motor, the roller inserted in the oblong-shaped recess moves upwards into the first portion of the recess, bringing it closer to the other roller. When the support part is not driven in translation by the motor, the roller inserted into the oblong-shaped recess falls back into the second portion of the recess and then moves away from the other roller (enabling the bag to be inserted or replaced).

The support part extends, for example, transversely to the main extension direction of the rollers, in a substantially vertical plane. The length of the oblong-shaped recess can be oriented advantageously along an axis oblique to the vertical direction, in particular along an axis forming an angle with this vertical direction of between 15 and 45 degrees, for example substantially equal to 20 degrees. According to one embodiment of the invention, each of the two rollers is rotatably mounted about its main axis of extension, within said at least one support part. Each of the two rollers can, for example, be mounted so as to rotate freely around a rod, which is itself inserted in said at least one support part.

According to yet another embodiment of the device for dispensing animal feed, said gripping element(s) are means for pinching two opposite edges of the bag and consist of two clamps, at least one of the two clamps being motorized, each clamp being configured to hold a lower edge of the bag by pinching, said lower edge being located on the lower part of the bag. This makes it possible to precisely control the opening or closing of the bag neck, and thus effectively control the dispensing of each dose of wet feed, without damaging the bag.

According to yet another embodiment of the device for dispensing animal feed, it further comprises a movable drawer inside which the feed receptacle is arranged, the drawer being movably mounted inside the casing between an open position wherein the feed is accessible from outside the casing and a closed position wherein the feed is inaccessible from outside the casing, and the device further comprises control means for the movable drawer, capable of controlling an opening or closing of the movable drawer. This further enhances the bacteriological and anti-oxidation protection of the wet feed. The reason is that the wet feed remains protected from the air after it has been dispensed into the receptacle, as the drawer is opened by the control means only while the animal is feeding. If the animal does not finish the wet feed, the drawer closes and the wet feed remains protected from oxidation and sources of pollution and contamination.

Advantageously, the mobile drawer is a removable drawer, and is, for example, clipped into an opening in the casing. This facilitates drawer removal for easy cleaning.

According to another embodiment of the device for dispensing animal feed, said device for dispensing animal feed comprises elements for locking the position of the bag when it is received in said unit, such as horizontal or vertical hinges, locks, or latches.

According to yet another embodiment of the device for dispensing animal feed, the feed receptacle is a removable, interchangeable receptacle.

Advantageously, the feed dispensing device further comprises a scale, for example an electronic scale, arranged within the mobile drawer. Such a scale enables each dose of wet feed dispensed, as well as the wet feed consumed by the animal (the difference between the weight of the drawer contents before and after opening), to be accurately weighed.

By way of illustration, each feed receptacle is a magnetized bowl, which is mounted on a load cell module for weighing said bowl.

This load cell module can be powered from the mains. Alternatively, or as a redundant power supply, it can comprise a circuit and a battery space, with one or more batteries coupled to the circuit and to the battery space.

According to yet another embodiment of the device for dispensing animal feed, the wet feed dispensing unit further comprises means for securing an upper portion of the bag inside the casing.

Advantageously, the means for securing the upper part of the bag inside the casing comprise a jaw fixed in the casing and configured to hold the upper part of the bag by squeezing over substantially its entire width. Such a jaw holds the bag securely in place inside the casing, and distributes the pulling of the bag over the entire width of the casing. The jaw is preferably coated with a rubber strip on its face in contact with the bag, such a rubber strip defining, for example, overlapping sawtooth patterns to facilitate the squeezing of the bag by the jaw.

According to yet another embodiment of the device for dispensing animal feed, the upper part of said wet feed dispensing unit comprises fastening elements for hanging a bag, which are selected from the group comprising rods, straight suspension rods, suspension rods having an elongated body with a curved shape, hooks, and hooks whose cross-section increases towards their base. Preferably, the base of these hooks has a circular cross-section. In fact, it is important that this cross-section should be devoid of any angles so as not to create a point of weakness in the bag.

Advantageously, the diameter of the bag hole intended to receive a hook is slightly smaller than the diameter of the corresponding hook base, so that when the bag hole comes into contact with the hook base, the material of the bag deforms. This deformation generates a bead of material in the part of the bag surrounding that hole, which creates more friction and thus ensures better grip and improved retention of the bag in position.

This design also allows the bag to be pulled tighter with the squeezing and/or pressing assembly and the blocks. It is then observed that the forces are better distributed.

According to yet another embodiment of the device for dispensing animal feed, the device further comprises a data processing unit and a camera connected to the data processing unit, the data processing unit being connected to the control means of the electromechanical device, the camera being positioned on a front face of the casing and being configured to capture images in front of the casing.

Preferably, the camera is an infrared camera. The infrared camera is configured, for example, so as to present a field of view substantially equal to 120 degrees.

According to yet another embodiment of the device for dispensing animal feed, the data processing unit comprises memory means storing a neural network, the neural network having been trained to learn using training data comprising data from at least one database containing animal images.

In this way, the data processing unit is able to detect the presence of a predetermined type of animal (e.g. the “cats” type) in front of the feed dispensing device (notably by corpulence detection via the camera), and thus initiate the feed supply sequence. Each dose of wet feed, for example, is extracted from the bag only if an animal corresponding to the predetermined type of animal (e.g. a cat) presents itself to the device. If the cat doesn't finish its dose of wet feed, the mobile drawer closes and the feed remains protected from oxidation and pollution. This gives the feed dispensing device according to the invention an automated and intelligent appearance. Preferably, the data processing unit is configured in such a way that, each time the neural network recognizes an animal in the camera's field of view and corresponding to the predetermined type of animal, the data processing unit stores a photo of the animal (taken by the camera) in its memory means.

According to yet another embodiment of the device for dispensing animal feed, it further comprises a unit for dispensing dry feed such as kibble, said dry feed dispensing unit being arranged inside the casing.

Preferably, this dry feed dispensing unit comprises an auger for dispensing said dry feed.

The feed dispensing device thus configured can therefore deliver both dry and wet feed (mixed diet) and, being controlled by electronic control means and by the (parameterized) data processing unit, notably enables a user to easily and flexibly manage the dietary transition of their pet (such as a cat) towards increasingly wet feed (for example, to progressively increase the ratio of calories provided by wet feed versus those provided by dry feed). The feed dispensing device is configured, for example, to have an autonomy (before refilling) of around two to five days for a bag of wet feed, and around twenty days for dry feed dispensing.

According to yet another embodiment of the device for dispensing animal feed, it comprises a luminous or audible indicator of device operation, connected to the data processing unit and positioned on one side of the casing (for example on a front side thereof). The device operation indicator is, for example, a light-emitting diode.

According to yet another embodiment of the device for dispensing animal feed, it comprises a speaker connected to the data processing unit and positioned on one side of the casing (for example on a front side thereof). The speaker is configured, for example, to broadcast a pre-recorded sound or voice within the data processing unit, typically the voice of an owner of the animal intended to be fed via the device according to the invention (the broadcasting of such a voice being intended to call the animal to approach the device).

According to yet another embodiment of the device for dispensing animal feed, the device further comprises wireless communication means, said wireless communication means being connected to the data processing unit and being based, for example, on a Wi-Fi protocol, on a Bluetooth protocol, or on any other protocol well known to the person skilled in the art. The device's wireless communication means are able to communicate with a mobile communication device and/or with a remote server, in particular to enable feed dose settings, manual activation of feed dispensing, reporting of the various parameters and monitoring of the parameters.

According to yet another embodiment of the device for dispensing animal feed, it comprises a material recovery device such as a crumb catcher.

This material recovery device is advantageously movable between a clearing position and an active position.

For example, it can slide over the feed receptacle.

According to yet another embodiment of the device for dispensing animal feed, it comprises members for squeezing the lower fasteners via a reverse-threaded screw.

By way of illustration only, it may comprise a motor and two fasteners moving in opposite directions, away from each other.

According to a second aspect, the invention also relates to a bag of wet animal feed, the bag being provided with a neck for opening the bag, the neck being deformable between an open position and a closed position and being provided on a lower part of the bag.

According to the invention, this bag is adapted to be received in a wet feed dispensing unit of a device for dispensing animal feed as previously described, and
said neck comprises continuous lips, separable from each other to define an opening of said bag for the passage of a portion of its contents, said lips forming a sealed barrier when tension is applied thereto by exerting a pull on at least one of the bag portions located laterally to said neck,
said neck being configured to present a cross-section of different shape for at least two distinct opening positions thereof, one of said opening positions being so-called forced, and corresponding to a cross-section of said neck of circular or substantially circular shape, when a push is performed thereon, and
the ratio between the width (LG) and the height (HG) of said neck, when it allows the passage of said wet feed, and when it is at rest, that is, not tensioned, is between 1.5 and 10, preferably between 2 and 4 and even more preferably equal to 2.5, so as to ensure a regular flow of said wet feed through said neck.

Advantageously, the neck of the bag described above has technical features ensuring a smooth flow of its contents when used or employed with a device for dispensing wet feed as described above. This avoids, for example, the formation of jets of wet feed, which make it impossible to control the amount of wet feed dispensed.

The bag also features at least two “stable opening geometries, or shapes” to allow adjustment to the rheology and/or phase number of the wet feed contained therein.

By “stable geometry or opening shape” of the bag neck, we mean that the configuration thereof remains stable over time when constant tension is applied to the parts of the bag arranged laterally to this neck, or on the contrary, in the absence of such tension.

Preferably, the bag is made from a single plastic material such as a thermoplastic, advantageously a polyolefin such as polypropylene (PP).

According to one embodiment of the bag of wet animal feed, it comprises means configured to cooperate with said squeezing and/or pressing assembly and with the gripping elements, or said gripping element and said holding element, of said feed dispensing device, to enable wet feed dispensing.

According to another embodiment of the bag of wet animal feed, it has a substantially rectangular shape when laid flat and not filled with wet feed, and the bag is provided with four orifices positioned at the four corners of the rectangle formed by the bag. Preferably, of the two orifices positioned at the upper corners of the rectangle formed by the bag, one of the orifices has an oblong shape, the length of the oblong-shaped orifice being oriented along the width of the rectangle formed by the bag, and the other orifice has a substantially triangular shape. Such configured orifices facilitate the installation and holding in position of the bag within a wet feed dispensing unit of a feed dispensing device.

According to yet another embodiment of the bag of wet animal feed, the means for securing the upper part of the bag inside the casing (typically the bag securing jaw) comprise a first pair of pins configured to be inserted into the two orifices positioned at the upper corners of the rectangle formed by the bag. The means for gripping at least one edge of the bag (typically motorized clamps) comprise a second pair of pins configured to be inserted into the two orifices positioned at the bottom corners of the rectangle formed by the bag. Such cooperation between the pins and the orifices in the bag enables easy installation of the bag within the device's wet feed dispensing unit.

According to yet another embodiment of the bag of wet animal feed, the ratio between the height (HE) of the funnel and the width (LG) of said neck, when it allows said wet feed to pass through, and when it is at rest, that is, not under tension, is greater than 1.5 and preferably greater than 2.

According to a third aspect, the invention also relates to an assembly comprising a device for dispensing animal feed as described above, and a bag of wet animal feed as described above, the bag of wet feed being installed within the device and being received in the wet feed dispensing unit of the device.

According to a fourth aspect, the invention also relates to a method of dispensing wet animal feed, implemented by a wet feed dispensing unit of a device for dispensing animal feed as described above, the method comprising steps of:
installing a bag of wet feed as described above within the wet feed dispensing unit, so that the neck of the bag extends opposite the feed receptacle; and
activating the control means of the electromechanical device, to control a dispensing of wet feed from the bag to the feed receptacle, the activation of the control means causing the pinching means to move towards the position of pushing said at least one edge of the bag towards the neck, allowing the opening of the neck.

According to one embodiment of the invention, the data processing unit activates the control means of the electromechanical device to control a dispensing of wet feed from the bag to the feed receptacle, said activation being caused by a recognition of a predetermined animal type by the neural network when an animal corresponding to said animal type is present in the camera's field of view.

According to one embodiment of the invention, each activation of the control means of the electromechanical device also results in a vertical descending movement of the two rollers inside the casing at a vertical descent pitch, the length by which the rollers descent at the vertical descent pitch being predetermined and corresponding to the dispensing of a predefined dose of wet feed.

According to yet another aspect of the invention, it relates to a device for dispensing feed for animals, this device comprising a casing including a feed receptacle and a wet feed dispensing unit, the wet feed dispensing unit being adapted to receive a removable bag of wet feed, adapted to be held and secured within the housing and provided with a neck for opening the bag, the neck being deformable between at least an open position and a closed position, being provided on a lower part of the bag and being arranged facing the feed receptacle when the bag is received in the wet feed dispensing unit, the wet feed dispensing unit comprising:
an electromechanical device for supplying wet feed from the bag to the feed receptacle; and
control means for the electromechanical device, capable of controlling the delivery of wet feed from the bag to the feed receptacle.

According to the invention, the upper part of said wet feed dispensing unit comprises fastening elements for hanging the upper part of said bag, these fastening elements being hooks whose base has a circular or substantially circular cross-section.

Preferably, the base of each of these hooks has a circular cross-section.

In fact, it is important that this cross-section should be devoid of any angles so as not to create a point of weakness in the bag.

Advantageously, the diameter of the bag hole intended to receive a hook is slightly smaller than the diameter of the corresponding hook base, so that when the bag hole comes into contact with the hook base, the material of the bag deforms. This deformation generates a bead of material in the part of the bag surrounding the hole, which creates more friction and thus ensures better grip and improved retention of the bag in position.

This design also allows the bag to be pulled tighter with the squeezing and/or pressing assembly and the blocks. It is advantageously observed that the forces are better distributed.

These hooks can be curved, for example.

The terms “horizontal”, “vertical” or “transverse”, “lower”, “upper”, “top”, “bottom”, “side” are defined in relation to the orientation of the feed dispensing device according to the invention. In particular, in this application, the term “vertical” refers to an orientation perpendicular to the horizon, while the term “horizontal” refers to an orientation parallel to the horizon.

The invention will be described in greater detail by means of non-limiting embodiments, and on the basis of the appended figures, including:

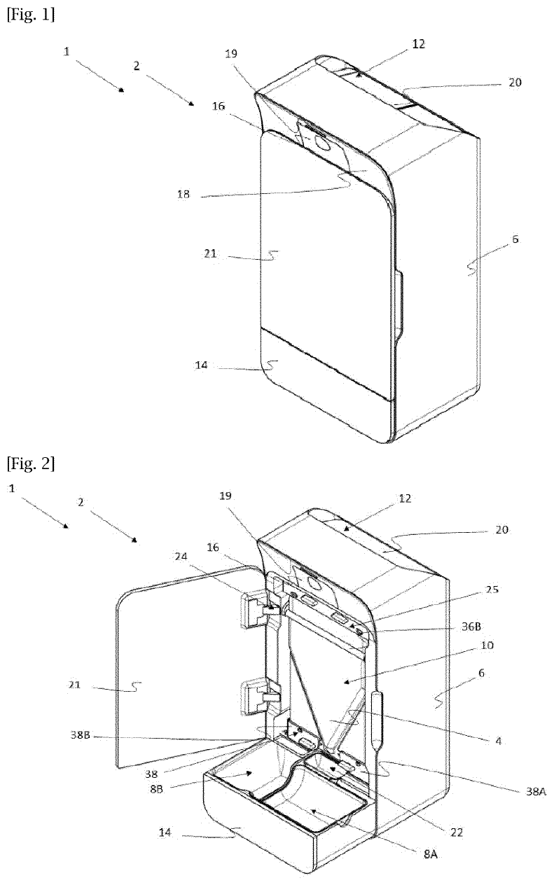

FIG. 1 is a perspective view of an assembly according to the invention comprising a feed dispensing device and a bag of wet feed, the device comprising a casing inside which the bag of wet feed and a feed receptacle are installed;

FIG. 2 is a view similar to that of FIG. 1 showing the interior of the casing, and in particular the bag of wet feed received in a wet feed dispensing unit of the device, in a bag installation configuration, the feed receptacle being in the open position, the wet feed dispensing unit comprising an electromechanical device for supplying wet feed from the bag to the feed receptacle, in the form of motorized rollers;

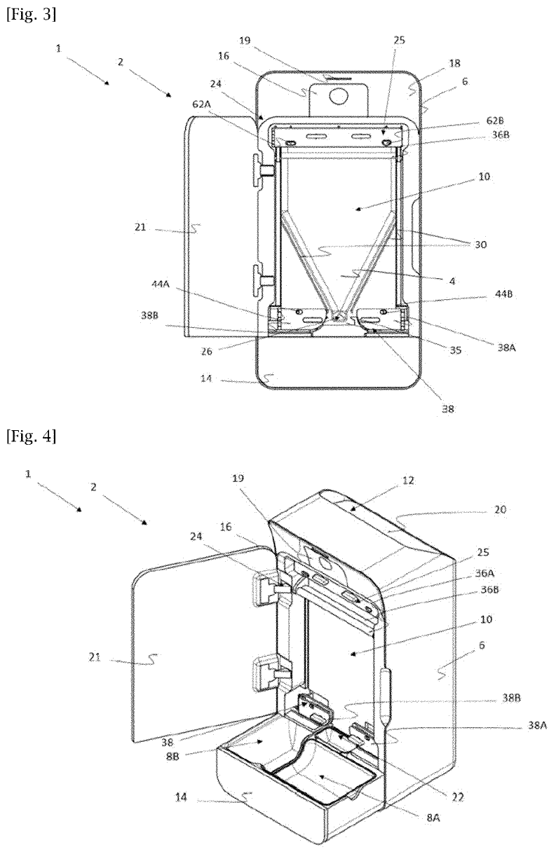

FIG. 3 is a front view of the assembly shown in FIG. 2, with the feed receptacle in the closed position;

FIG. 4 is an analogous view to FIG. 2, with the bag of wet feed omitted;

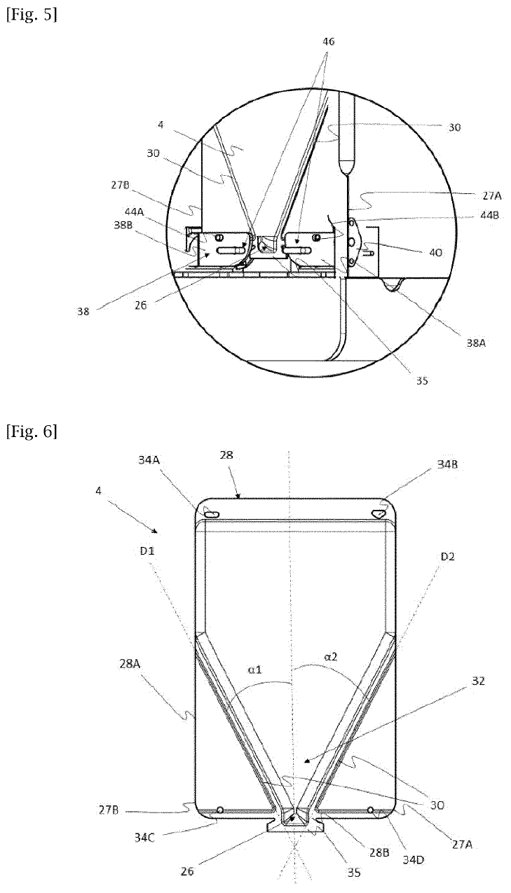

FIG. 5 is a perspective view showing a detail of the assembly shown in FIG. 2;

FIG. 6 is a front view of the bag of wet feed shown in FIG. 2;

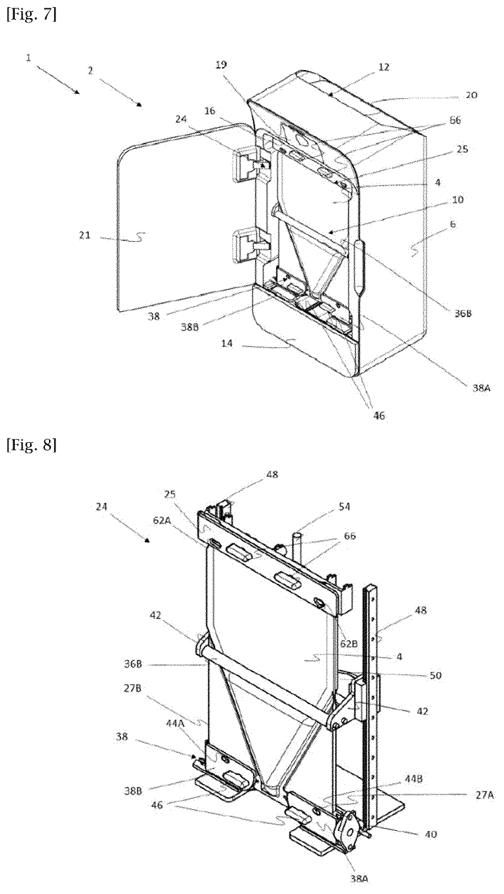

FIG. 7 is a view analogous to that of FIG. 2, in a lowered position of the rollers, the feed container being in a closed position, the electromechanical device comprising means for pinching two opposite edges of the bag of wet feed;

FIG. 8 is a perspective view of the bag of wet feed and the interior of the casing of the feed dispensing device shown in FIG. 7;

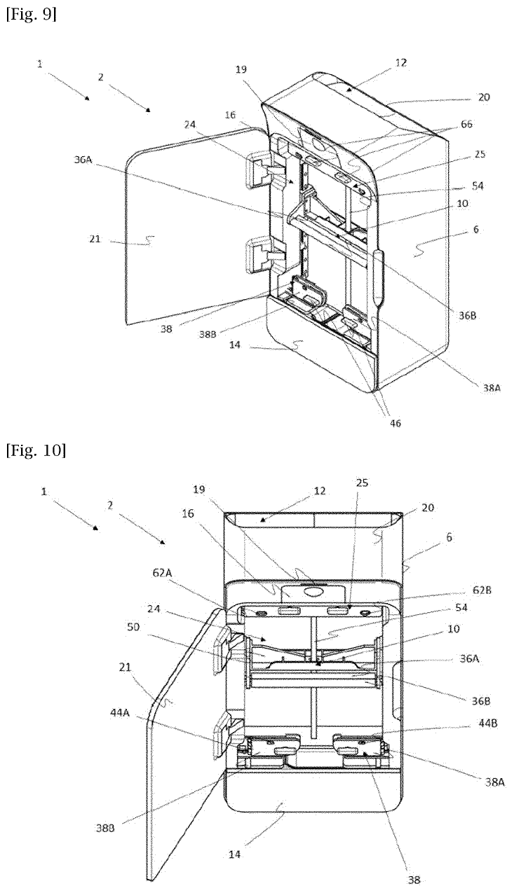

FIG. 9 is an analogous view to FIG. 7, with the bag of wet feed omitted;

FIG. 10 is another perspective view of the assembly of FIG. 9;

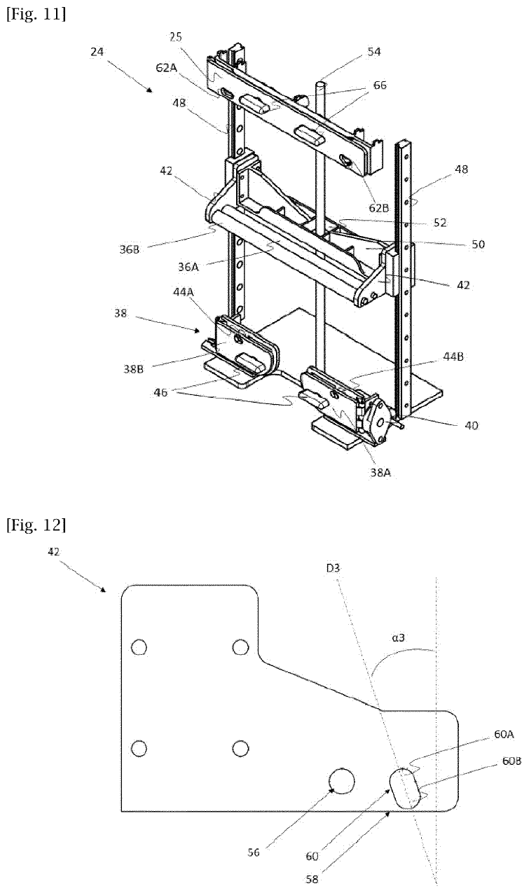

FIG. 11 is an analogous view to that of FIG. 8, with the bag of wet feed omitted, the electromechanical device comprising two roller support parts;

FIG. 12 is a side view of one of the roller support parts shown in FIG. 11;

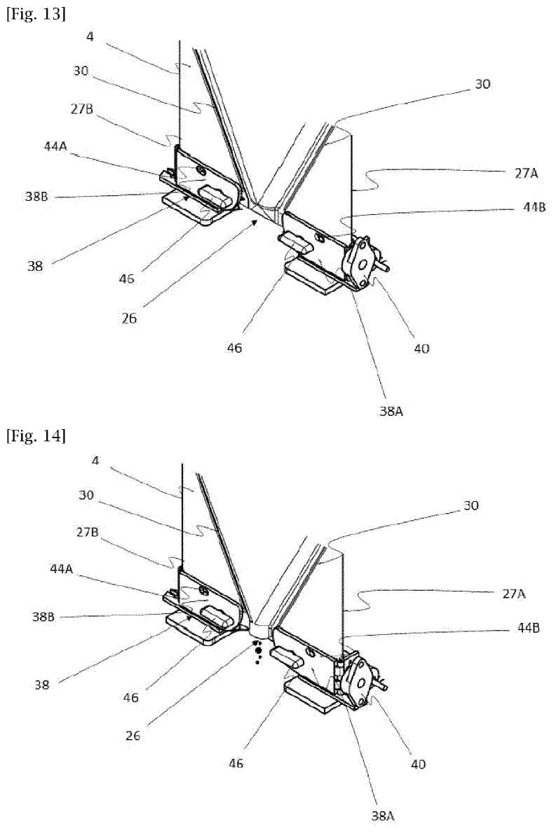

FIG. 13 is a perspective view of the pinching means and a lower part of the bag of wet feed of FIG. 7, in a non-wet-feed-dispensing configuration corresponding to a pull position of the pinching means; and

FIG. 14 is a view analogous to that of FIG. 13, in a wet-feed-dispensing configuration corresponding to a push position of the pinching means;

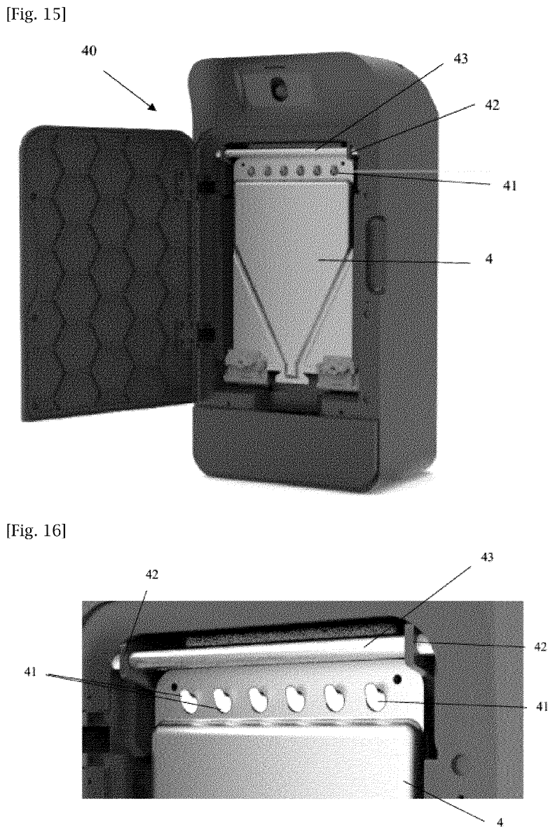

FIG. 15 is a schematic representation of an assembly comprising a feed dispensing device and a bag of wet feed according to another embodiment of the invention, this assembly being seen from the rear;

FIG. 16 is an enlarged, partial view of the assembly shown in FIG. 15, showing the hooks for hanging the bag, which are located in the upper part of the casing.

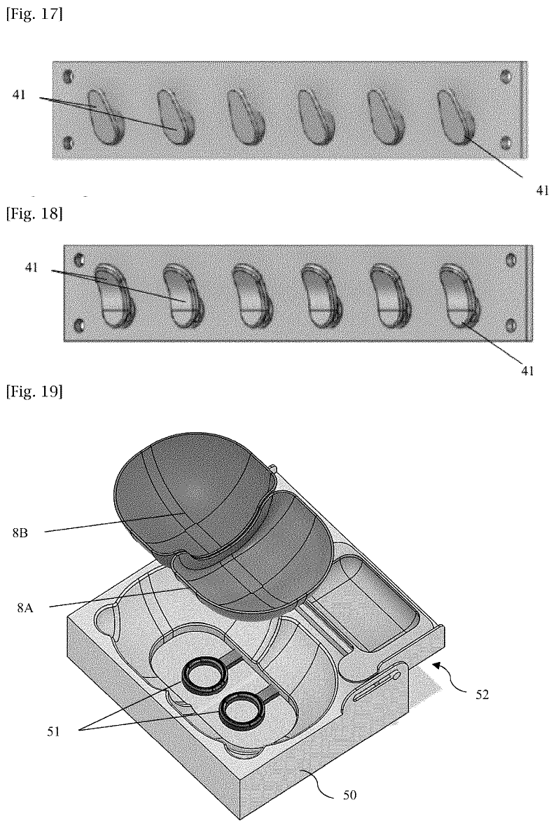

FIG. 17 is a schematic representation of the hooks used to hang the bag in another embodiment;

FIG. 18 is a schematic representation of the hooks used to hang the bag in another embodiment;

FIG. 19 is a schematic view of the movable drawer received in the lower part of the casing of the feed dispensing device according to another embodiment of the invention;

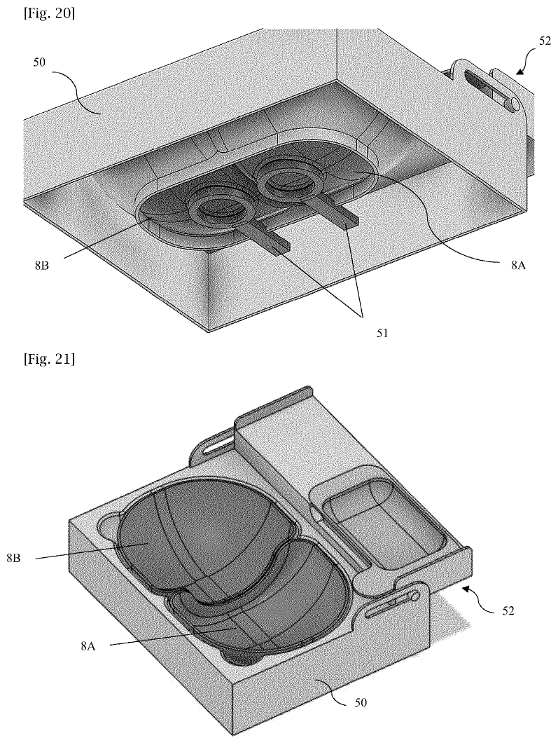

FIG. 20 is a perspective view from below of the movable drawer in the lower part of the casing;

FIG. 21 shows a material recovery device according to one particular embodiment of the invention;

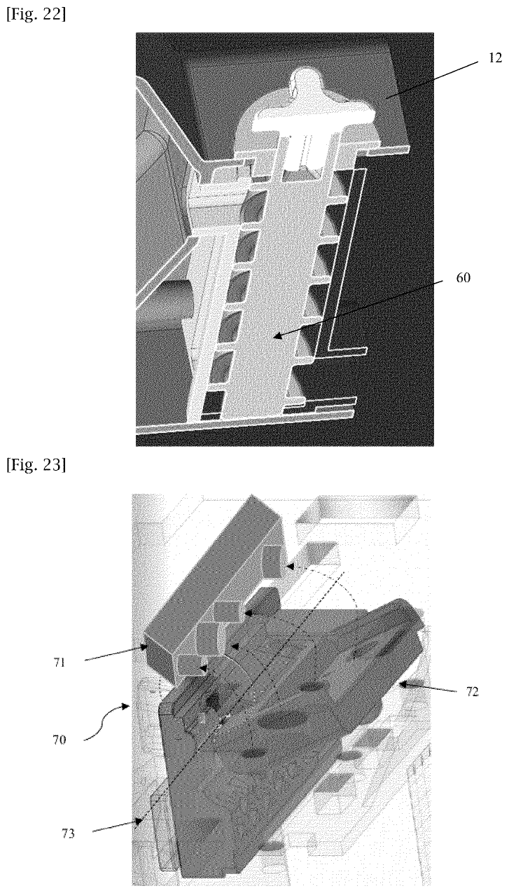

FIG. 22 shows a dry feed dispensing unit according to one particular embodiment of the invention;

FIG. 23 is a partial schematic representation of a block of the electromechanical device of a wet feed dispensing unit according to another particular embodiment of the invention;

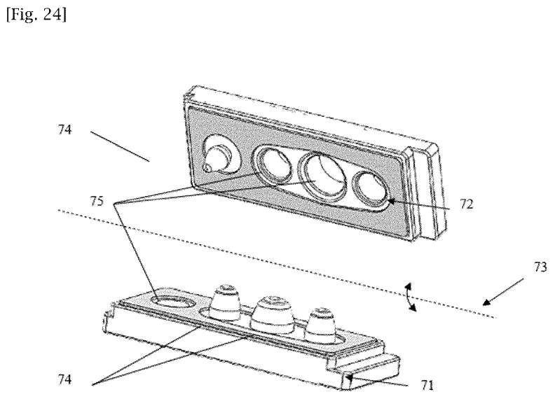

FIG. 24 is a schematic representation of only the jaws of the gripping element of the block shown in FIG. 23;

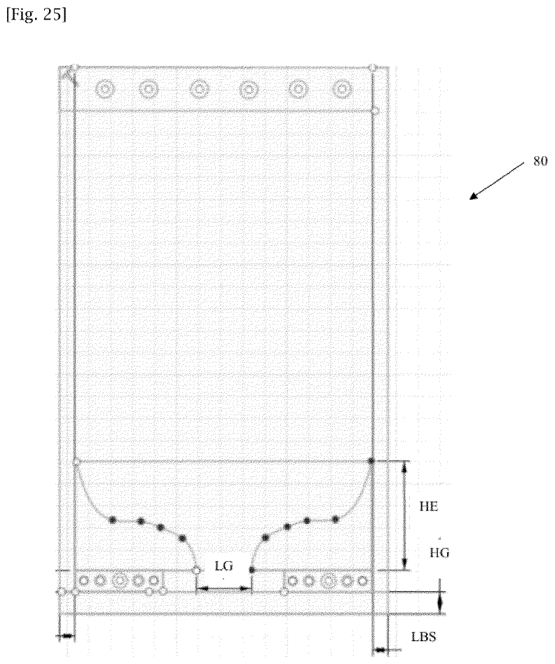

FIG. 25 is a schematic representation of a bag according to another embodiment of the invention;

FIGS. 1 to 3, 5 and 7 show an assembly 1 comprising a device for dispensing animal feed 2 and a bag of wet animal feed 4 installed within the device 2. The device 2 is typically designed to dispense feed for small pets such as cats or dogs.

The feed dispensing device 2 comprises a casing 6, inside which at least one feed receptacle 8A, 8B, a wet feed dispensing unit 10, a dry feed dispensing unit 12, a scale, a data processing unit, and wireless communication means are arranged (these last three elements are not shown in the figures for the sake of clarity). Preferably, as shown in FIGS. 1 to 4, 7, 9 and 10, the feed receptacle 8A, 8B is arranged inside a drawer 14 movably mounted inside the casing 6, and the feed dispensing device 2 further comprises means for controlling the movable drawer 14 (not shown in the figures for the sake of clarity). Even more preferably, the feed dispensing device 2 further comprises a camera 16 connected to the data processing unit and positioned on one side of the casing 6, typically on a front side 18 of the casing 6 (the front side 18 of the casing 6 being defined as the side facing the animal when it wishes to feed). Even more preferably, the feed dispensing device 2 further comprises a light or sound indicator 19 to indicate the operation of the device 2, connected to the data processing unit and positioned on one side of the casing 6, typically on the front side 18 of the casing 6. Even more preferably, the feed dispensing device 2 further comprises a speaker (not shown in the figures for the sake of clarity), the speaker being connected to the data processing unit and being positioned on one side of the casing 6, typically on the front side 18 of the casing 6. Even more preferably, the feed dispensing device 2 further comprises an interface for manual control of the device 2 (not shown in the figures for the sake of clarity), connected to the data processing unit and positioned on one side of the casing 6, typically on an upper side 20 of the casing 6. The feed dispensing device 2 further comprises a series of servomotors and sensors which will not be described in greater detail here. As shown in FIGS. 1 to 4 and 7 to 10, the casing 6 is advantageously provided with a door 21 pivotably mounted on the casing 6 and giving access to the interior of the casing 6 when open.

In the particular embodiment shown in FIGS. 2 and 4, the feed dispensing device 2 comprises two feed receptacles 8A, 8B, namely a first receptacle 8A for receiving wet feed and a second receptacle 8B for receiving dry feed. The first feed receptacle 8A is arranged opposite the bag of wet feed 4. The second feed receptacle 8B is arranged opposite the dry feed dispensing unit 12 (the latter being a conventional dry feed dispensing unit which will not be described in greater detail hereafter, but which notably comprises a dry feed reservoir). The dry feed is, for example (but is not limited to) dry kibble. Each feed receptacle 8A, 8B is, for example, a removable, interchangeable receptacle. The drawer 14 is movably mounted inside the casing 6 between an open position (shown in FIGS. 2 and 4) wherein the feed is accessible from outside the casing, and a closed position (shown in FIGS. 1, 3, 7, 9 and 10) wherein the feed is inaccessible from outside the casing 6. The mobile drawer 14, for example, is clipped into an opening formed in the casing 6. The mobile drawer 14 can thus be unclipped from the casing 6 for easy cleaning of the entire drawer 14. The control means of the mobile drawer 14 are able to control the opening or closing of the mobile drawer 14. In the particular embodiment shown in FIGS. 2 and 4, the mobile drawer 14 also contains another removable receptacle 22, of the “crumb catcher” type. Such a “crumb catcher”-type receptacle 22 collects wet feed residue which may fall from the bag 4 when the mobile drawer 14 is in its open position, or when the mobile drawer 14 is in its translational movement between its open and closed positions. The scale (not shown in the figures), which is for example an electronic scale connected to the data processing unit, is arranged within the movable drawer 14. Such a scale enables each dose of wet feed dispensed, as well as the wet feed consumed by the animal (the difference between the weight of the contents of the drawer 14 before and after opening), to be accurately weighed.

The wet feed dispensing unit 10 comprises an electromechanical device 24 for supplying wet feed from the bag 4 to the first feed receptacle 8A; and means for controlling the electromechanical device 24 (not shown in the figures but, for example, connected to or comprising the data processing unit). The control means for the electromechanical device 24 are capable of controlling the delivery of wet feed from the bag 4 to the first feed receptacle 8A. The wet feed is, for example, (but is not limited to) animal pâté. Preferably, the wet feed dispensing unit 10 further comprises means 25 for securing an upper part of the bag 4 inside the casing 6.

The bag of wet animal feed 4 is removably mounted in the feed dispensing device 2, and is received in the wet feed dispensing unit 10 of the device 2. More precisely, as can be seen in FIGS. 2, 3, 7 and 8, the bag of wet feed 4 is held and secured inside the casing 6, in particular by means of the means 25 for securing the upper part of the bag 4. The bag 4 is provided with a neck 26 for opening the bag 4, provided on a lower part of the bag 4. The neck 26 is deformable between an open position (shown in FIG. 14) and a closed position (shown in FIGS. 2, 3, 5, 7, 8 and 13), and is arranged opposite the first feed receptacle 8A when the bag 4 is received in the wet feed dispensing unit 10. The neck 26 is configured to be selectively opened or closed by pushing or pulling on at least one edge 27A, 27B of the bag 4.

According to a particular embodiment of the invention, shown in FIGS. 2, 3 and 5 to 8, the bag of wet feed 4 is formed by two walls (in particular two substantially rectangular walls) joined together over a portion 28A of their periphery 28 and defining between them a volume for receiving wet feed. As shown in FIG. 6, the two walls are not connected to each other at another portion 28B of their periphery 28 and are configured to form the neck 26 for opening the bag 4 at this other portion 28B. The neck 26 thus comprises two lips, each forming part of a separate wall of the bag, the two lips being spaced apart in the open position of the neck 26 (visible in FIG. 14), the two lips being in contact with each other and extending parallel to each other in the closed position of the neck 26 (visible in FIGS. 2, 3, 5, 7, 8 and 13). Preferably, as shown in FIG. 14, the neck 26 has an eye-shaped cross-section in its open position. In a variant not shown, the neck 26 has a substantially circular or elliptical cross-section in its open position.

The walls of the bag 4, for example, are made of a metallic material such as aluminum or an aluminum-based alloy, or a plastic material such as polypropylene. The use of a polypropylene material such as this ensures the recyclability of the bag 4. The walls of the bag 4 have one or more internal seams 30 on their inside, connecting the walls to each other inside the bag 4. Preferably, as shown in FIG. 6, the walls of the bag 4 have two internal seams 30 on their inner face connecting the walls to each other inside the bag 4, the two internal seams 30 being arranged to form a “V” when the bag 4 is laid flat and not filled with wet feed. The two internal seams 30 have a symmetrical arrangement around a median longitudinal plane of the bag (such a plane being a vertical plane extending perpendicular to the plane of extension of the rectangle formed by the bag when empty of feed), each internal seam 30 extending in a direction D1, D2 which forms an angle α1, α2 with the direction corresponding to the length of the rectangle formed by the bag when empty of feed (this direction also being the vertical direction). Preferably, and as shown in FIG. 6, each of the angles α1, α2 is between 25 degrees and 35 degrees, preferably substantially equal to 30 degrees. The internal seams 30 are interconnected to form a funnel 32 inside the bag 4, in fluid communication with the opening neck 26 of the bag 4. Such a funnel shape enables wet feed to be guided efficiently and fluidly downwards through the bag 4, and in particular towards the neck 26, which has a narrower diameter. This ensures a controlled, stable flow of wet feed from the outlet 26, from whatever height the rollers 36A, 36B (see below) descent with respect to the bag 4.

As shown in FIG. 6, the bag of wet feed 4 is provided with four orifices 34A, 34B, 34C, 34D to enable it to be secured to the wet feed dispensing unit 10, inside the casing 6. The four orifices 34A, 34B, 34C, 34D are positioned at the four corners of the rectangle formed by the bag 4 when it is laid flat and empty of feed. Two first “top” orifices 34A, 34B are positioned at the top corners of the rectangle formed by the bag 4. One of these orifices 34A has an oblong shape, the length of this orifice 34A being oriented along the width of the rectangle formed by the bag 4. The other orifice 34B, positioned at an upper corner of the rectangle formed by the bag 4, is substantially triangular in shape. Two further “bottom” orifices 34C, 34D, typically circular in shape, are positioned at the bottom corners of the rectangle formed by the bag 4. Preferably, as shown in FIG. 6, each top orifice 34A, 34B is vertically aligned with a corresponding bottom orifice 34C, 34D, with a lateral variation of plus or minus 1 cm. Each bottom orifice 34C, 34D is spaced from the edge of neck 26 by a distance of, for example, between 2.5 cm and 5.5 cm, preferably substantially equal to 4 cm.

Preferably, as can be seen in FIGS. 3, 5 and 6 in particular, the bag of wet feed 4 is provided on its lower part with a lid 35 to protect the neck 26, projecting downwards below the neck 26. The protective lid 35 seals the neck 26 before the bag 4 is used, thus preventing any loss of feed before it is placed in the device 2. FIGS. 7, 8, 13 and 14 show the bag 4 in use in the device 2 (for dispensing wet feed), with the lid 35 having been previously removed by a user to make the neck 26 functional. The lid 35 is advantageously pre-cut to facilitate tearing by a user.

By way of example, the neck 26 has a length of between 16 mm and 24 mm, preferably approximately 20 mm, after the bag 4 has been opened and the lid 35 torn off. In its closed position, for example, the neck 26 has a width of between 16 mm and 24 mm, preferably substantially equal to 20 mm, the width being measured in the direction of the thickness of the bag 4.

As a further indication, when the neck 26 has a substantially circular cross-section in its open position, the diameter of the neck 26 is, for example, between 11 mm and 15 mm, preferably substantially equal to 13 mm.

The electromechanical device 24 comprises means 36A, 36B for squeezing and/or pressing the bag 4, and means 38 for pinching at least one edge 27A, 27B of the bag 4. The electromechanical device 24 further comprises at least one motor or servomotor 40, for example an electric servomotor 40, connected to the squeezing means 38 to enable their actuation. Preferably, when the squeezing and/or pressing means 36A, 36B are rollers (see below), the electromechanical device 24 further comprises two parts 42 supporting the rollers 36A, 36B, and a further motor or servomotor (not shown in the figures) connected to the rollers 36A, 36B to enable their actuation.

The gripping means 38 are mounted so as to be movable between a push position in which one of the edges 27A of the bag 4 is pushed towards the neck 26 (such a position corresponding to the opening position of the neck 26 and being shown in FIG. 14), and a pull position in which the edge 27A of the bag 4 is pulled away from the neck 26 (such a position corresponding to the closing position of the neck 26 and being shown in FIGS. 2, 3, 5, 7, 8 and 13). The pinching means 38 are thus configured to selectively open or close the neck 26 of the bag 4.

In the particular embodiment shown in FIGS. 1 to 14, the squeezing means 38 are means for squeezing two opposite bottom edges 27A, 27B of the bag 4, and consist of two clamps 38A, 38B. Each clamp 38A, 38B comprises two flaps, one of which is pivotably mounted relative to the other (e.g. by means of a hinge). Each clamp 38A, 38B is configured to clamp one of the lower edges 27A, 27B of the bag 4. The two clamps 38A, 38B are thus arranged on either side of the neck 26 of the bag 4 when the bag 4 is held by the clamps 38A, 38B. At least one of the two clamps 38A, 38B is connected to the electric servomotor 40 (in the example shown in the figures, the first clamp 38A is connected to the electric servomotor 40). The first clamp 38A is thus mounted for horizontal translation, between the push position in which the edge 27A of the bag 4 is pushed towards the neck 26 and the pull position in which the edge 27A of the bag 4 is pulled away from the neck 26, the translational movement of the first clamp 38A lying substantially in the same plane as the plane of extension of the bag 4 when it is empty of feed. As shown in FIGS. 3, 8, 10 and 11, each clamp 38A, 38B is provided, for example, on the inner face of one of its wings with a pin 44A, 44B designed to be inserted into one of the bottom orifices 34C, 34D of the bag 4, to enable effective positioning and holding of the bag 4 in the clamp 38A, 38B (which bottom orifice 34C, 34D is located on the lower edge 27B, 27A of the bag 4 held by the clamp 38A, 38B in question). Preferably, each clamp 38A, 38B is provided with a means 46 for locking the bag 4 in position in the clamp 38A, 38B, such a means 46 being, for example, a latch for locking the clamp flaps.

In the particular example shown in FIGS. 1 to 14, the means 36A, 36B for squeezing and/or pressing the bag 4 comprise two parallel motorized rollers. Each roller 36A, 36B extends in a direction transverse (preferably perpendicular) to the vertical direction. The bag 4 extends between the rollers 36A, 36B and is held by squeezing between the rollers 36A, 36B, with the neck 26 of bag 4 extending below the rollers 36A, 36B, facing the first feed receptacle 8A. The two parallel rollers 36A, 36B extend in the same horizontal plane when in position of squeezing the bag 4. The motorization of the two rollers 36A, 36B, for example, is achieved via the following arrangement, shown in FIGS. 8 to 12: the ends of each roller 36A, 36B are received in the two support parts 42, each support part 42 being mounted so as to be movable in vertical translation on a vertical rail 48. The two support parts 42 are connected to each other via a horizontal crosspiece 50 running behind the rollers 36A, 36B, each support part 42 extending in front of the horizontal crosspiece 50. The horizontal crosspiece 50 has a central opening 52 through which a vertical auger 54 can pass. The auger 54 is mechanically connected to the servomotor shaft previously mentioned in conjunction with the rollers 36A, 36B. The opening 52 is sized to match the diameter of the auger 54 and is threaded so that its internal thread cooperates with the thread of the auger 54. In this way, when the servomotor is activated, it rotates the auger 54, which in turn vertically translates the assembly consisting of the horizontal crossbar 50, the support parts 42 and the rollers 36A, 36B, this vertical translation movement taking place along the vertical rails 48.

As shown in FIG. 12, each support part 42 comprises a first portion 56 for holding one of the two rollers 36A, and a second portion 58 for holding the other roller 36B. Each support part 42 extends in a substantially vertical plane. The first portion 56 of the support part 42 is configured to form a pivot connection for the roller 36A which it holds. As shown in FIG. 12, the first portion 56 of the part 42 consists, for example, of a circular orifice into which one end of the first roller 36A is inserted. The second portion 58 of the part 42 is provided with an oblong-shaped recess 60 configured to receive, depending on the translational movement of the rollers 36A, 36B in the casing 6, the second roller 36B in a first portion 60A of the recess 60, corresponding to a position in which the rollers 36A, 36B are brought together, or in a second portion 60B of the recess 60, corresponding to a position in which the rollers 36A, 36B are moved apart. Thus, when downward pressure is exerted on the support part 42, for example via the action of the servomotor on the auger 54 (to push the wet feed down the bag 4), the second roller 36B moves up into the first portion 60A of the recess 60, from the second portion 60B of this recess 60. This movement thus brings the second roller 36B closer to the first roller 36A. In the absence of pressure exerted on the support part 42, the second roller 36B falls back into the second portion 60B of the recess 60, causing the rollers 36A, 36B to move apart. The first and second portions 60A, 60B of the oblong-shaped recess 60 are offset from each other vertically and horizontally. The length of the oblong-shaped recess 60 can be oriented advantageously along an axis D3 oblique to the vertical direction, in particular along an axis D3 forming an angle α3 with this vertical direction of between 15 and 45 degrees, for example substantially equal to 20 degrees. Each support part 42 is made of a plastic material, for example.

In the particular embodiment shown in the figures, each of the two rollers 36A, 36B is preferably rotatably mounted about its main axis of extension, in each of the two support parts 42. Each of the two rollers 36A, 36B, for example, is mounted so as to rotate freely around a rod, which is itself inserted in each of the two support parts 42.

The means 36A, 36B for squeezing and/or pressing the bag 4 enable the bag 4 to be pressed so that the wet feed contained in the bag 4 is gradually moved down to the bottom of the bag, thus exerting pressure on the neck 26 of the bag 4 to ensure good flow and a controlled rate of wet feed when the neck 26 is in its open position. A linear regression law can advantageously be implemented in the data processing unit to control the movement of the rollers 36A, 36B (profile, speed, pressure, height descended, etc.), in order to control the flow of wet feed and the uniform dispensing of doses whatever the position of the rollers 36A, 36B. The wet feed dispensing unit 10 is thus equipped with at least one sensor (connected to the data processing unit, and not shown in the figures) for measuring the vertical position of the rollers 36A, 36B. A slight upward and downward movement of the rollers 36A, 36B (over a very short length compared to the total descent range of the rollers 36A, 36B) may be executed by the control means after each delivery of a dose of wet feed. This generates a little slack at the top of bag 4 to facilitate subsequent dispensing of wet feed. The means 38 for pinching at least one edge 27A, 27B of bag 4 are used to control the opening and closing of the bag 4. Thanks to the particular configuration of the bag of wet feed 4 (and in particular its deformable neck 26), combined with the presence in the electromechanical device 24 of means 36A, 36B for squeezing and/or pressing the bag 4 and means 38 for pinching at least one edge 27A, 27B of the bag 4, the feed dispensing device 2 according to the invention thereby makes it possible to dose a precise amount of wet feed suitable for the animal (and in particular to deliver precise personalized doses of feed, typically doses of wet feed ranging from 10 g to 100 g).

The means 38 for pinching at least one edge 27A, 27B of the bag 4 thus ensure hermetic (and airtight) closure of the bag 4 when the device 2 is not being used by the animal (and in particular when no animal is recognized by the data processing unit—see below). The interior of the neck 26 (and therefore of the bag 4) therefore remains airtight outside periods of wet feed dispensing, due to the sealing of the neck 26. The contents of the opened bag 4 remain air-and bacteria-tight for the duration of the emptying process, as the opening surface of the neck 26 is minimal, almost always sealed, with no residues (which fall by gravity), and inside a fully enclosed machine (no contact with pets or insects). This guarantees effective bacteriological and anti-oxidation protection for wet feed.

In the particular embodiment shown in the figures, the means 25 for securing the upper part of the bag 4 inside the casing 6 consist of a jaw secured in the casing 6. The jaw 25 extends over substantially the entire width of the rectangle formed by bag 4 and comprises two flaps, one of which is pivotably mounted relative to the other (e.g. by means of a hinge). The jaw 25 is configured to clamp (or pinch) the upper part of bag 4, over substantially its entire width. The jaw 25 is preferentially coated with a rubber strip on its face(s) in contact with bag 4, such a rubber strip (not visible in the figures) defining, for example, sawtooth-like tangles (not shown) to facilitate the squeezing of the bag 4 by the jaw 25.

As shown in FIGS. 3, 8 and 11, the jaw 25 is provided, for example, on the inner face of one of its wings, with two pins 62A, 62B designed to be inserted respectively into the two top orifices 34A, 34B of the bag 4, to enable effective positioning and holding of the bag 4 in the jaw 25. For example, two orifices corresponding in shape to the pins 62A, 62B (and the two top orifices 34A, 34B of bag 4) are provided on the outer flap of jaw 25 to allow these pins 62A, 62B to pass through when the jaw 25 is closed. Preferably, the jaw 25 has at least one (and advantageously two in the example shown in the figures) mean(s) 66 for locking the bag 4 in position in the jaw 25, such means 66 being, for example, a latch for locking the flaps of the jaw 25.

The data processing unit is connected to the control means of the electromechanical device 24 and to the control means of the movable drawer 14. Alternatively, the data processing unit constitutes such control means. The data processing unit is also connected to the wireless communication means. The data processing unit comprises memory means storing a neural network. The neural network has previously been trained using training data comprising data from at least one database containing animal images (typically images of cats). In this way, the data processing unit is able to detect the presence of a predetermined type of animal (e.g. the “cats” type) in front of the feed dispensing device 2 (notably by corpulence detection via the camera 16), and thus initiate the feed supply sequence. Preferably, the data processing unit is configured in such a way that, each time the neural network recognizes an animal in the field of view of the camera 16 and corresponding to the predetermined type of animal, the data processing unit saves a photo of the animal (taken by the camera 16) in its memory means. The saving of such a photo makes it possible to inform the animal's owner that the animal has been recognized by the device 2, and that the device 2 has therefore triggered the dispensing of feed. In a second phase, anonymized photos of the animals can be used to feed training data to the neural network.

The data processing unit is implemented, for example, in the form of a microcontroller or a Printed Circuit Board (PCB), within which firmware is integrated. The firmware is equipped, for example, with an artificial intelligence module storing the neural network.

The device's 2 wireless communication means are able to communicate with a communication device (landline or mobile) and/or with a remote server, in particular to enable configuration of feed doses, manual activation of feed dispensing, reporting of the various parameters and monitoring of the parameters. The wireless communication means of the device 2 are thus configured to transmit and/or receive data over a wireless network to and/or from the mobile communication device and/or remote server. The communication device is, for example, a smartphone, a tablet or a computer (though not limited thereto), on which a dedicated web application is installed, to enable remote control of the device 2 and use of the various configuration, reporting and parameter-monitoring functions.

The camera 16 is configured to capture images in front of the casing 6. Preferably, the camera 16 is an infrared camera. The infrared camera 16 is configured, for example, so as to present a field of view substantially equal to 120 degrees.

The operating method of the feed dispensing device 2, and in particular the wet feed dispensing method according to the invention implemented by wet feed dispensing unit 10 of the device 2, will now be described. Initially, a user of the device 2 installs a bag of wet feed 4 within the wet feed dispensing unit 10, so that the neck 26 of the bag 4 extends opposite the first feed receptacle 8A. To do this, the user opens the door 21 of the casing 6, opens the clamps 38A, 38B and the jaw 25, inserts the bag 4 from bottom to top between the rollers 36A, 36B, then adjusts the bag 4 so as to insert the pins 44A, 44B into the bottom orifices 34C, 34D and insert the pins 62A, 62B into the top orifices 34A, 34B. The user then closes the clamps 38A, 38B and jaw 25, locks the latches 46, 66, and tears the lid 35 off the bag 4. As shown in FIG. 13, the neck 26 of the bag 4 is in its sealing position, and the means 38 for gripping at least one edge 27A, 27B of the bag 4 are in the pull position in which the edge 27A is pulled away from the neck 26. The user then closes the door 21. Initially, the drawer 14 is in its closed position (shown in FIGS. 1, 3, 7, 9 and 10).

The method for dispensing wet feed comprises a subsequent step consisting in activating the control means of the electromechanical device 24, to control a dispensing of wet feed from the bag 4 to the first feed receptacle 8A. This activation of the control means is, for example, performed manually by the user (either via the manual control interface of device 2, or remotely via their mobile communication device), or is performed automatically by the data processing unit after recognition by the neural network that an animal corresponding to the predetermined type of animal (e.g. a cat) is present in the field of view of the camera 16. In the latter case, the data processing unit saves a photo of the animal (taken by the camera 16) in its memory means.

The activation of the control means of the electromechanical device 24 causes the means 36A, 36B for squeezing and/or pressing the bag 4, and means 38 for pinching at least one edge 27A, 27B of the bag 4, to move. In particular, at least one of the two clamps 38A, 38B (in this case the first clamp 38A in the example shown in the figures) moves in horizontal translation between the pull position in which the edge 27A of the bag 4 is pulled away from the neck 26 (shown in FIG. 13) and the push position in which the edge 27A of the bag 4 is pushed towards the neck 26 (shown in FIG. 14). This movement of the first clamp 38A causes the neck 26 to deform and to move from its closed position to its open position. The two rollers 36A, 36B then descend vertically inside the casing 6, at a vertical descent pitch. The length by which the rollers 36A, 36B descend at this vertical descent pitch is predetermined (e.g. via implementation of the linear regression law within the data processing unit) and corresponds to the dispensing of a predefined dose of wet feed in the first feed receptacle 8A. It should be noted that the length by which the rollers 36A, 36B descend at this vertical descent pitch may therefore vary depending on the vertical position of the rollers 36A, 36B in the casing 6.

Once the predefined dose of wet feed has been dispensed into the first feed container 8A (that is, when the rollers 36A, 36B have completed their vertical downward movement at the vertical movement pitch), at least one of the two clamps 38A, 38B (in this case, the first clamp 38A in the example shown in the figures) moves in horizontal translation, between the position in which the edge 27A of the bag 4 is pushed towards the neck 26 (shown in FIG. 14) and the position in which the edge 27A of the bag 4 is pulled away from the neck 26 (shown in FIG. 13). This movement of the first clamp 38A causes the neck 26 to deform and to move from its open position to its closed position. In addition, the data processing unit activates the control means of the movable drawer 14, which then controls the movement of the movable drawer 14 towards its open position (shown in FIGS. 2 and 4). The animal can then access the dose of wet feed dispensed. In the case of the automatic recognition of the presence of an animal in the field of vision of the camera 16, each dose of wet feed is thus extracted from the bag 4 only if an animal corresponding to the predetermined type of animal (e.g. a cat) appears in front of the device 2. If the animal doesn't finish its dose of wet feed, the mobile drawer 14 closes and the dispensed wet feed remains protected from oxidation and pollution.

The dispensing of dry feed via the device 2 has not been discussed in the context of the steps of the method detailed above, but such dispensing is of course possible via manual control by the user and/or detection of the animal by the neural network, followed by activation of the dry feed dispensing unit 12 to deliver a dose of dry feed.

FIGS. 15 and 16 show an assembly comprising a feed dispensing device and a bag of wet feed according to another embodiment of the invention, this assembly being seen from the rear.

The elements bearing the same references as those shown in FIGS. 1 to 4 represent the same objects, which will not be described again below.

This dispensing device 40 differs from the one described above in that it has six fastening hooks 41, positioned in the upper part of its wet feed dispensing unit 10, for hanging the bag.

These fastening hooks 41, which in this case have a flared shape with a cross-section that increases towards their base, are designed to cooperate with corresponding orifices located at the upper end of the bag in order to hang the bag.

The number of orifices depends on the rheology of the wet feed contained in bag 4, the strength of the motor(s), and the material(s) making up the bag 4.

The feed dispensing device 2 further comprises guide rail portions 42 positioned opposite one another in the upper part of the casing, said guide rail portions 42 enabling said rollers 43 to be guided between a stowed, or retracted, position and an operating position. The upper ends of these guide rail portions 42 bringing said rollers 43 into their retracted position, are inclined to increase the distance separating these rollers 43 and thus facilitate positioning of the bag in the wet feed dispensing unit 10, when the rollers 43 are in their retracted position.

FIGS. 17 and 18 show different hook geometries for hanging the bag in the upper part of the wet feed dispensing unit 10.

FIGS. 19 and 20 show a partial, enlarged view of the animal feed dispensing device 2 according to a further embodiment.

In particular, they represent the lower part of the casing 6 of the feed dispensing device 2, which accommodates the feed receptacles 8A, 8B mounted in a movable drawer 50.

This drawer 50 is movable between an extended position, wherein it is placed at least partly outside the casing 6 to allow the animal to feed, and a position for dispensing feed into each bowl 8A, 8B, wherein this movable drawer 50 is housed in the casing 6 so that, in particular, the bowl 8A is positioned under the neck 26 of the bag 4.

A scale, e.g. an electronic scale, is arranged within the mobile drawer 50. Such a scale enables each dose of wet feed dispensed, as well as the wet feed consumed by the animal (the difference between the weight of the drawer contents before and after opening), to be accurately weighed. By way of illustration, each feed receptacle 8A, 8B is a magnetized bowl, which is mounted on a corresponding load cell 51 in order to weigh that bowl 8A, 8B.

FIG. 21 shows a material recovery device 52 , such as a crumb collector according to one particular embodiment of the invention. As shown, this crumb catcher 52 is placed in an active position in the lower portion of the casing 6 so that, being located under the neck 26 of the bag 4, it can recover any material lost from the bag after it has been sealed.

In this active position of the crumb catcher 52, the movable drawer 50 is in the extended position, so that the bowls 8A, 8B are out of the casing 6 and accessible to the animal for feeding.

To reach the feed dispensing position (not shown), the crumb catcher 52 and the movable drawer 50 supporting the bowls 8A, 8B move simultaneously so that the crumb catcher 52 moves from its active position to a clearing position, incorporating a housing provided for this purpose, with the bowl 8A then positioned under the neck 26 of the bag 4.

FIG. 22 shows a dispensing unit 20 for dry feed such as kibble according to one particular embodiment.

This dry feed dispensing unit 20 features an auger 60 for dispensing this dry feed.

Advantageously, the groove of this auger 60 is 1.5 cm +/−0.3 cm.

FIGS. 23 and 24 are schematic and partial representations of one block 70 of the electromechanical device of a wet feed dispensing unit according to another particular embodiment of the invention.

This block 70 comprises a gripping element formed by a gripping jaw 71, 72 for grasping said bag portion disposed laterally to the neck 4 from each of the opposite faces of the bag 4.

This gripping jaw comprises two jaw parts 71, 72 which can be tilted against each other about a swivel axis 73 and each comprise a gripping face.

These gripping faces comprise complementary shapes and counter-forms, such as protrusions 74 and recesses 75 having complementary shapes, which are placed opposite each other so that when the gripping jaw 71, 72 closes around one portion of the bag, each shape is received in a corresponding counter-form to reinforce the gripping of the part of the bag thus grasped by said gripping element.

FIG. 25 shows a bag 80 according to another embodiment of the present invention.

This bag 80 has the following parameters:
Either HU, the “useful height” of the bag, corresponding to the height of the receptacle, measured between the bottom of the top seam of the bag and the top of the neck after the tab has been opened,
or HL, the free height of the receptacle, measured between the bottom of the top seam of the bag and the start of the inner seam that extends away from the lateral edges
or HE the height of the funnel, measured between the start of the internal seam that runs away from the lateral edges of the bag and the bottom of the neck after opening.
or LG the width of the neck, measured flat with the bag closed. This is a width, not a diameter.
or HG the height of the neck, measured between the height where the internal seams become parallel to the edges of the bag, and the bottom of the neck after opening.
or LBS, the width of the seamed strip.

This bag 80 of wet animal feed advantageously has values within the following ranges:
LG is between 1.5 and 5 cm
HG is between 0.5 and 3 cm
the LG/HG ratio is between 1.5 and 10, preferably between 2 and 4, and even more preferably equal to 2.5,
the HE/LG ratio is greater than 1.5, and even more preferably greater than 2.

It can be seen that such values for the construction of the bag of wet animal feed guarantee homogeneous dispensing of the wet feed contained in the bag, when the latter is implemented with the feed dispensing device of the invention.

1. A device for dispensing feed for animals, this device comprising a casing including a feed receptacle and a wet feed dispensing unit, the wet feed dispensing unit being adapted to receive a removable bag of wet feed, this wet feed dispensing unit being configured to ensure the holding and securing of said bag so that the latter then extends at least partially along a main axis, said bag being provided with an opening neck for the bag, the neck being deformable between at least an open position and a closed position, being provided on a lower part of the bag and being arranged facing the feed receptacle when the bag is received in the wet feed dispensing unit, the wet feed dispensing unit comprising:
an electromechanical device for supplying wet feed from the bag to the feed receptacle; and
control means for the electromechanical device, capable of controlling the delivery of wet feed from the bag to the feed receptacle,
wherein the electromechanical device comprises:
at least one block comprising a gripping element for holding a portion of said bag arranged laterally to said neck, said gripping element being mounted for translational movement along an axis that is transverse or substantially transverse to said main axis, and a motor for driving said gripping element to move between a position of said portion of said bag held in this way, corresponding to a neck-opening position, and a position of pulling away said portion of said bag held in this way, corresponding to said neck-closing position,
said blocks being configured to hold a first portion and a second portion of said bag placed laterally to said neck, and located on either side thereof, when said electromechanical device comprises two blocks,
said electromechanical device comprising at least one element for holding a second portion of said bag placed laterally to said neck, when it comprises a single block for gripping a first portion of said bag placed laterally to said neck, said first and second portions being located on either side of said neck, and
said blocks, or said block and said holding element, being configured to enable said neck to be opened or closed selectively, with said first and second portions of the bag being tensioned in the pull position to close said neck and guarantee the bacteriological and anti-oxidation protection of the wet feed.

2. The device for dispensing animal feed according to claim 1, wherein each gripping element is configured to grip a portion of said bag located between said neck and a corresponding lateral edge of said bag, said neck being excluded.

3. The device for dispensing animal feed according to claim 1, wherein said holding element is a fixed gripping element or a lug.

4. The device for dispensing animal feed according to claim 1, wherein the neck of said bag having at least two stable opening geometries, when said or each block holds a corresponding portion of said bag disposed laterally to the neck in predetermined opening positions thereof, each block is configured to pass selectively from the neck-closing position to each opening position, each of these positions being reached by translational movement of said block or blocks along said transverse axis.

5. The device for dispensing animal feed according to claim 4, wherein a first of said opening positions corresponding to a stable opening geometry of the neck, the so-called forced-open position, corresponds to a position of said block or of at least one of said blocks, wherein it exerts a thrust on a corresponding part of said bag disposed laterally to said neck.

6. The device for dispensing animal feed according to claim 5, wherein another of said opening positions corresponding to a stable opening geometry of the neck, known as the normal opening position of the bag, corresponds to a position of said block or of at least one of said blocks, wherein the corresponding part of said bag disposed laterally to said neck is not tensioned by said block.

7. The device for dispensing animal feed according to claim 1, wherein each block is configured so that the transverse or substantially transverse axis of movement of its gripping element is positioned between the lower and upper ends of said neck when the bag is held in said casing.

8. The device for dispensing animal feed according to claim 1, wherein each gripping element comprises one or more objects selected from the group comprising teeth, pointed elements such as needles or pins, pressure bars with or without rubber, a fastening pin or stud intended to cooperate with a corresponding orifice placed in the lower part of the bag, shapes and counter-shapes, and combinations of these elements.

9. The device for dispensing animal feed according to claim 1, wherein each gripping element is formed by a gripping jaw for gripping said bag portion disposed laterally to said neck by each of the faces of said bag.

10. The device for dispensing animal feed according to claim 1, wherein said electromechanical device further comprises an assembly for squeezing and/or pressing said bag, said assembly defining a main axis along which said assembly for squeezing and/or pressing said bag moves to squeeze and/or press at least a portion of said bag.

11. The device for dispensing animal feed according to claim 10, wherein said assembly for squeezing and/or pressing the bag comprises two parallel motorized rollers, each of these rollers being mounted for translational movement inside the casing along said main axis and extending in a direction transverse to said main axis, the bag being intended to extend between the rollers and being held by squeezing between the rollers when the bag is received in the wet feed dispensing unit, the neck of the bag extending below the rollers.

12. The device for dispensing animal feed according to claim 11, further comprising at least one pair of guide rail portions positioned opposite each other in the upper part of the casing, said guide rail portions enabling said rollers to be guided between a stowed or retracted position and an operating position, wherein said rollers are engaged with said bag, the upper ends of said rail portions bringing said rollers to their retracted position, being inclined to increase the distance separating these rollers and facilitate the positioning of the bag in the wet feed dispensing unit when the rollers are in the retracted position.

13. The device for dispensing animal feed according to claim 12, wherein said retracted position is located above fastening elements for hanging said bag in the wet feed dispensing unit.

14. Device for dispensing animal feed according to claim 11, wherein the electromechanical device further comprises at least one roller support part, said at least one support part being connected to a motor or servomotor enabling its translational movement inside the casing, said at least one support part having a first portion for holding one of the two rollers configured so as to form a pivot connection for said roller, and a second portion for holding the other roller, said second portion of the part being provided with an oblong-shaped recess configured to receive, as a function of the translational movement of the rollers in the casing, said other roller in a first portion of the recess, corresponding to a position in which the rollers are brought together, or in a second portion of the recess, corresponding to a position in which the rollers are moved apart, the first and second portions of the oblong-shaped recess being offset from one another vertically and/or horizontally.

15. The device for dispensing animal feed according to claim 1, further comprising a data processing unit and a camera connected to the data processing unit, the data processing unit being connected to control means of the electromechanical device, the camera being positioned on a front face of the casing and being configured to capture images in front of the casing.

16. The device for dispensing animal feed according to claim 15, wherein the data processing unit comprises memory means storing a neural network, the neural network having been trained for its learning by means of training data comprising data from at least one database containing animal images.

17. The device for dispensing animal feed according to claim 1, wherein the upper part of said wet feed dispensing unit comprises fastening elements for hanging a bag, which are selected from the group comprising rods, straight suspension rods, suspension rods having an elongated body with a curved shape, hooks, and hooks whose cross-section increases towards their base.

18. A bag of wet animal feed, the bag being provided with a neck for opening the bag, the neck being deformable between an open position and a closed position and being provided on a lower portion of the bag, wherein the bag is adapted to be received in a wet feed dispensing unit of a device for dispensing animal feed according to any of the preceding claims, and in that
said neck comprises continuous lips, separable from each other to define an opening of said bag for the passage of a portion of its contents, said lips forming a sealed barrier when tension is applied thereto by exerting a pull on at least one of the bag portions located laterally to said neck,
said neck being configured to present a straight cross-section of different shape for at least two distinct opening positions thereof, one of said opening positions being so-called forced, and corresponding to a cross-section of said neck of circular or substantially circular shape, when a push is performed on that neck, and
the ratio between the width (LG) and the height (HG) of said neck, when it allows the passage of said wet feed, and when it is at rest, that is, not tensioned, is between 1.5 and 10 preferably so as to ensure a regular flow of said wet feed through said neck.

19. The bag of wet animal feed according to claim 18, wherein the bag further comprises means configured to cooperate with the gripping elements, or said gripping element and said holding element, of said feed dispensing device, to enable wet feed dispensing.

20. (canceled)
